(19) United States
(12) Patent Application Publication
(10) Pub. No.: US 2018/0136789 A1
(43) Pub. Date: May 17, 2018

(54) SENDER-INITIATED CONTROL OF INFORMATION DISPLAY WITHIN MULTIPLE-PARTITION USER INTERFACE

(71) Applicant: Google Inc., Mountain View, CA (US)

(72) Inventors: Alexander Faaborg, Mountain View, CA (US); Daniel Marc Gatan Shiplacoff, Los Altos, CA (US); Michael Andrew Cleron, Menlo Park, CA (US); Lee Brandon Keely, San Francisco, CA (US); Michael Steven Feldstein, Mountain View, CA (US); Christian Robertson, Pleasanton, CA (US); Richard Eugene Fulcher, Sunnyvale, CA (US); Matias Gonzalo Duarte, Mountain View, CA (US)

(73) Assignee: Google Inc., Mountain View, CA (US)

(21) Appl. No.: 14/253,803

(22) Filed: Apr. 15, 2014

Related U.S. Application Data
(60) Provisional application No. 61/939,213, filed on Feb. 12, 2014.

(51) Int. Cl. G06F 3/0481

(52) U.S. Cl. CPC G06F 3/0481

(57) ABSTRACT

In some examples, a computing device includes at least one processor, wherein the at least one processor is configured to output for display, a graphical user interface comprising a plurality of partitions, wherein each respective partition of the plurality of partitions is a non-overlapping region of the graphical user interface and each respective partition of the plurality of partitions is individually addressable by the window manager module. The at least one processor may receive from an application module, a request to output, for display, information indicated by the application module, wherein the request addresses a particular partition of the plurality of partitions in which to display the information. The at least one processor may output for display a window including the information in the particular partition.

This application claims the benefit of U.S. Provisional Application No. 61/939,213, filed Feb. 12, 2014, the entire content of which is incorporated herein in its entirety

### BACKGROUND

Some computing devices may output one or more graphical windows for display. A graphical window (or “window”), generally, may include graphical content generated by an application. For example, one window may include a draft email message and another window may include a spreadsheet. Modern operating systems may display multiple windows in a single graphical user interface. The position of each respective window in the single graphical user interface may be based on one or more absolute x, y coordinate values.

While a computing device may output information for display that is generated by an application executing locally at the computing device, the computing device may also receive information from a remote computing device to output for display. A computing device that receives such information from a remote computing device may output a window for display that includes at least a portion of the received information. However, the computing device may output the window in an area of the graphical user interface that currently includes a different, active window. Displaying the window in a region of the graphical user interface that already includes a different active window may interrupt the user's focus on the active window. For instance, the newly-displayed window with the information may overlap the active window, thereby at least partially obstructing the user's view of the content of the active window. Thus, some computing devices may display information in a manner that interrupts a user's workflow.

### SUMMARY

In some examples, a method may include outputting, by a window manager module that is operable by a computing device, for display, a graphical user interface comprising a plurality of partitions, wherein each respective partition of the plurality of partitions is a non-overlapping region of the graphical user interface that is individually addressable by the window manager module and includes a respective set of windows that are arranged in a respective predefined alignment imposed by the window manager module and located within the respective partition, the respective predefined alignment shared by each window within the respective set of windows, and wherein the respective set of windows is positioned within the respective partition of the plurality of positions based on a location of the respective partition within the graphical user interface. The method may include receiving, by the window manager module and from an application module, a request to output, for display, information indicated by the application module, wherein the request addresses a particular partition of the plurality of partitions in which to display the information. The method may include outputting, by the window manager module, for display, and based at least in part on the request, a particular window in the respective, predefined alignment within the particular partition, the particular window including the information indicated by the application module.

In some examples, a computer-readable storage medium may be encoded with instructions that, when executed, cause at least one processor to: output, by a window manager module that is operable by the at least one processor, and for display, a graphical user interface comprising a plurality of partitions, wherein each respective partition of the plurality of partitions is a non-overlapping region of the graphical user interface and each respective partition of the plurality of partitions is individually addressable by the window manager module, wherein each respective partition of the plurality of partitions includes a respective set of windows that are arranged in a respective predefined alignment that is imposed by the window manager module, located within the respective partition, and shared by each window within the respective set of windows, and wherein the respective set of windows is positioned within the respective partition of the plurality of positions based on a location of the respective partition within the graphical user interface. The computer-readable storage medium may be encoded with instructions that, when executed, cause at least one processor to receive, by the window manager module and from an application module, a request to output, for display, information indicated by the application module, wherein the request addresses a particular partition of the plurality of partitions in which to display the information. The computer-readable storage medium may be encoded with instructions that, when executed, cause at least one processor to output, by the window manager module, for display, and based at least in part on the request, a particular window in the respective, predefined alignment within the particular partition, the particular window including the information indicated by the application module.

In some examples, a computing device may include at least one processor, wherein the at least one processor is configured to: output, by a window manager module that is operable by the at least one processor, and for display, a graphical user interface comprising a plurality of partitions, wherein each respective partition of the plurality of partitions is a non-overlapping region of the graphical user interface and each respective partition of the plurality of partitions is individually addressable by the window manager module, wherein each respective partition of the plurality of partitions includes a respective set of windows that are arranged in a respective predefined alignment that is imposed by the window manager module, located within the respective partition, and shared by each window within the respective set of windows, and wherein the respective set of windows is positioned within the respective partition of the plurality of positions based on a location of the respective partition within the graphical user interface. The at least one processor may be configured to receive, by the window manager module and from an application module, a request to output, for display, information indicated by the application module, wherein the request addresses a particular partition of the plurality of partitions in which to display the information. The at least one processor may be configured to output, by the window manager module, for display, and based at least in part on the request, a particular window in the respective, predefined alignment within the particular partition, the particular window including the information indicated by the application module.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device that is configured to determine, based on intent information specified in a message, a partition of a multiple-partition graphical user interface in which to display content specified by the message, in accordance with one or more aspects of the present disclosure.

FIG. 2 is a block diagram illustrating an example computing device, in accordance with one or more aspects of the present disclosure.

FIG. 3 is a block diagram illustrating an example computing device that outputs graphical content for display at a remote device, in accordance with one or more techniques of the present disclosure.

FIG. 4 is a conceptual diagram illustrating an example computing device that is configured to generate an additional partition in response to request and display content in the additional partition, in accordance with one or more aspects of the present disclosure.

FIG. 5 is a conceptual diagram illustrating an example computing device that is configured to transition between display modes in response to a request, in accordance with one or more aspects of the present disclosure.

FIG. 6 is a conceptual diagram illustrating an example computing device that is configured to move a window from one partition to another in response to a request, in accordance with one or more aspects of the present disclosure.

FIG. 7 is a flow diagram illustrating example operations of a computing device to determine, based on intent information specified in a message, a partition of a multiple-partition graphical user interface in which to display content specified by the message, in accordance with one or more aspects of the present disclosure.

### DETAILED DESCRIPTION

In general, this disclosure is directed to techniques for determining, based on intent information specified in a message, a partition of a multiple-partition graphical user interface in which to display content specified by the message. For instance, a computing device may execute an operating system that includes a window manager module. The window manager module may cause the computing device to display a graphical user interface that is divided into multiple, different partitions that comprise non-overlapping regions within the graphical user interface. Each of the partitions may be individually addressable by the window manager module, such that each partition has a partition identifier. In this way, the window manager module may position a particular window within a partition using a partition identifier. As further described herein, the window manager module may concurrently display two windows in separate partitions of the graphical user interface. For instance, one partition may be larger than the other (e.g., in the case of two partitions). In some examples, a window displayed in the larger partition may be the primary focus of the user (e.g., a word processing document being edited by the user). The smaller partition may include a different window with information that the user wishes to view concurrently with the window in the larger partition, but without changing the window displayed in the larger partition and otherwise interrupting the user's workflow (e.g., an instant messaging conversation with a co-author of the word processing document).

In some examples, the operating system may receive a message that indicates content for display within the graphical user interface. The message may be generated by an application module executing at the computing device or may be generated by an application module executing at a remote computing device. In accordance with techniques of the disclosure, the window manager module may determine intent information within the message that indicates in which partition to display content indicated by the message. That is, techniques of the disclosure allow an application module to, by using intent information within a message, specify in which partition an operating system should display such content. In other words, rather than the window manager module (or operating system) specifying which partition to display content of a message, techniques of the disclosure allow the application module itself that generated and/or sent the message to indicate in which partition the operating system should display content indicated by the message. In this way, techniques of the disclosure provide a flexible framework that enables an application module to indicate content for display in a message, and in addition, specify in which partition a window manager module may include such content for display.

As one example, a multiple-partition graphical user interface may include a larger partition and a non-overlapping, smaller partition that collectively comprise the entire area of the graphical user interface. The larger partition may include a window with a word-processing document being edited by the user and the smaller partition may include a window with a web browser. The computing device may receive a message from a remote computing device that includes instant messaging text from the co-author of the word-processing document. The remote computing device may include an application module (e.g., instant messaging client) that specifies intent information within the message that instructs the window manager module to include the instant messaging text in a smallest partition of a group of partitions. Responsive to receiving the message and determining the intent information, the window manager module may determine the partition identifier of the smallest partition of the group of partitions (in the current example, the “smaller partition”). Based on the partition identifier of the smaller partition, the window manager module can position the instant messaging text within the smatter partition, such that computing device outputs, for display, the instant messaging text in the smaller partition concurrently with the word-processing document included in the larger partition. In this way, the window manager module may use the intent information to display the instant messaging text in smaller partition and avoid interrupting the user's focus on the word-processing document. Consequently, the user may view the content of the message from the co-author without disrupting the user's current workflow.

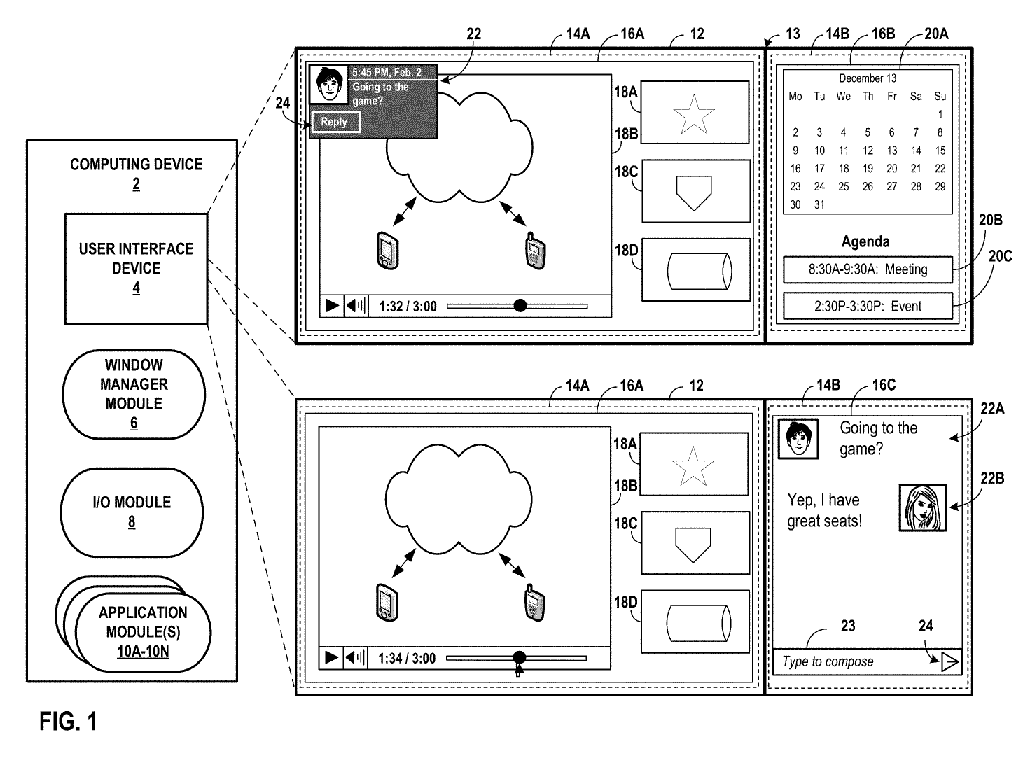

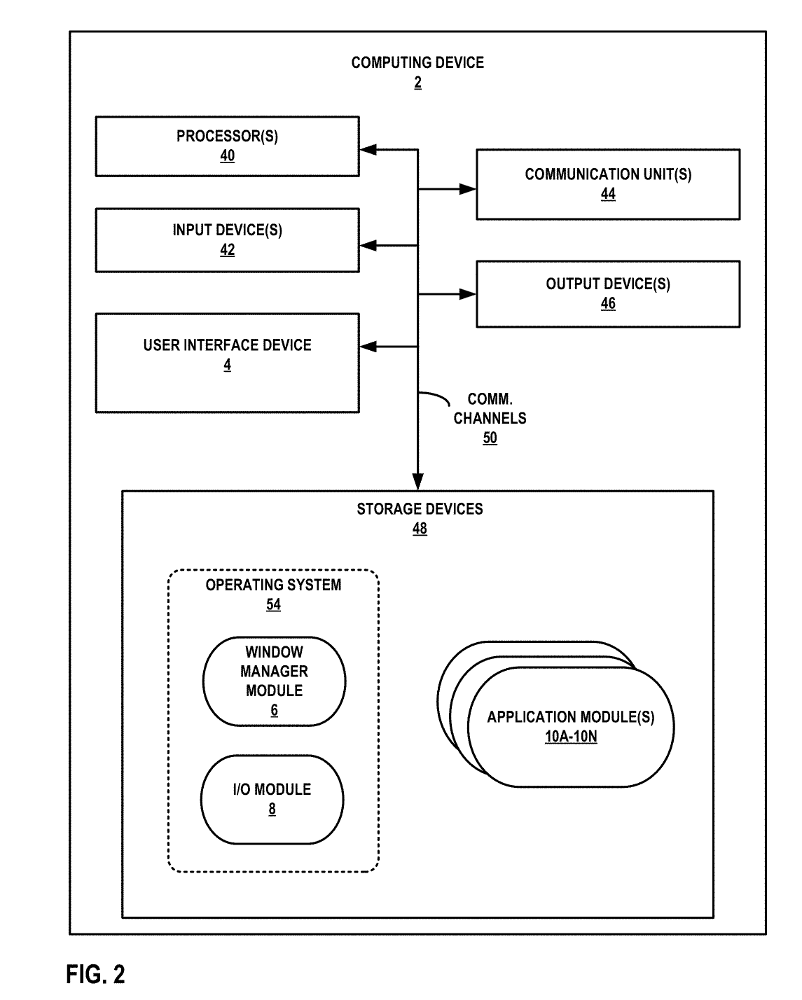

FIG. 1 is a conceptual diagram illustrating an example computing device that is configured to determine, based on intent information specified in a message, a partition of a multiple-partition graphical user interface in which to display content specified by the message, in accordance with one or more aspects of the present disclosure. In the example of FIG. 1, computing device 2 may be a mobile phone. However, in other examples, computing device 2 may be a tablet computer, a personal digital assistant (PDA), a laptop computer, a portable gaming device, a portable media player, an e-book reader, a watch, television platform, or another type of computing device. Further details computing device 2 are described in the examples and description of FIG. 2.

As shown in FIG. 1, computing device 2 includes user interface device 4. User interface device 4 of computing device 2 may function as an input device and as an output device for computing device 2. In some examples, user interface device 4 may include an integrated presence-sensitive input device and a display device. For instance, user interface device 4 may function as a presence-sensitive input device using a presence-sensitive screen, such as a resistive touchscreen, a surface acoustic wave touchscreen, a capacitive touchscreen, a projective capacitance touchscreen, a pressure sensitive screen, an acoustic pulse recognition touchscreen, or another presence-sensitive screen technology. User interface device 4 may function as an output device using any one or more of a liquid crystal display (LCD), dot matrix display, light emitting diode (LED) display, organic light-emitting diode (OLED) display, e-ink, or similar monochrome or color display capable of outputting visible information to the user of computing device 2.

User interface device 4 of computing device 2 may include a presence-sensitive screen that may detect user input from a user of computing device 2. User interface device 4 may receive indications of the user input by detecting one or more tap and/or non-tap gestures, continuous gestures, or other any multi-touch gestures from a user of computing device 2 (e.g., the user touching or pointing to one or more locations of presence-sensitive display 4 with a finger or a stylus pen). A presence-sensitive screen of user interface device 4 may present output to a user. For instance, a presence-sensitive screen of user interface device 4 may present various user interfaces of applications (e.g., an electronic message application, an Internet browser application, etc.) executing at computing device 2. A user of computing device 2 may provide user input at user interface device 4 to interact with one or more of these applications.

Computing device 2 may include window manager module 6, input/output (I/O) module 8, and application modules 10A-10N. Modules 6, 8, and 10A-10N may perform operations described herein using software, hardware, firmware, or a mixture of both hardware, software, and firmware residing in and executing on computing device 2. Computing device 2 may execute modules 6, 8, and 10A-10N with multiple processors. Computing device 2 may execute any of modules 6, 8, and 10A-10N as or within a virtual machine executing on underlying hardware. Modules 6, 8, and 10A-10N may be implemented in various ways. For example, any of modules 6, 8, and 10A-10N may be implemented as a downloadable or pre-installed application or “app.” In another example, any of modules 6, 8, and 10A-10N may be implemented as part of an operating system of computing device 2.

As shown in FIG. 1, computing device 2 may include window manager module 6. Window manager module 6 may maintain and control the arrangement of partitions within a multiple-partition graphical user interface (e.g., graphical user interface 12). Graphical user interface 12 in some examples may be a desktop environment having partitions 14A-14B overlaid on a background. In some examples, partitions 14A-14B may represent different logical regions of graphical user interface 12. For instance, in some examples, partitions 14A-14B may not represent different graphical user interfaces, but may be different logical regions of a single graphical user interface. In some examples, partitions 14A-14B may be separate graphical user interfaces output within the same screen of a display device. In some examples, graphical user interface may be divided by a divider line 13 that is displayed to indicate different partitions 14A-14B, while in other examples, no such divider line may be displayed. For example, graphical user interface 12 may include a gap between partitions 14A-14B. Graphical user interface 12 may not display boundaries of partitions 14A-14B in some examples.

In some examples, window manager module 6 may maintain information that defines different partitions within graphical user interface 12. For instance, window manager module 6 may maintain a partition identifier for each partition within graphical user interface 12. A partition identifier may be a value that uniquely identifies a partition within graphical user interface 12. Window manager module 6 may use a partition identifier to reference or address a particular partition. In some examples, window manager module 6 maintains the partition identifiers in a data structure, such as a list, set, etc. Window manager module 6 may maintain and/or determine a quantity of partitions in graphical user interface 12. In some examples, graphical user interface 12 may be output for display at a single display device (e.g., by user-interface device 4). In some examples, graphical user interface 12 may be output for display at multiple-display devices, such that a set of partitions of graphical user interface 12 are output for display at a first display device and a second set of partitions of graphical user interface 12 are output for display at a second display device.

In some examples, a “partition” does not refer to a particular display device. That is, in some examples, computing device 2 may maintain identifiers for different display devices, and separately maintain partition identifiers for different partitions within a graphical user interface. In some examples, a single display device may output for display a graphical user interface that includes separately addressable partitions. In some examples, multiple displays may each respectively output for display respective graphical user interfaces that each include separately addressable partitions. In some examples, a single graphical user interface that does not include separately addressable partitions and the single graphical user interface is split to span across two separate display devices does not include a first partition on the first display device and a second partition on the second display device for purposes of this disclosure, because a partition, for purposes of this disclosure, may be separately addressable by windows manager module 6 within a graphical user interface, and a partition may be independent of the identity of display devices which may also be identified by computing device 2.

Window manager module 6 may maintain information that defines the respective sizes of different partitions within graphical user interface 12. In some examples, window manager module 6 may receive indications of user input that cause a change in the size of one or more partitions within graphical user interface 12. In some examples, a size of a partition within graphical user interface 12 may be based on a default system value, such as a constant or initial value. Window manager module 6 may change the size of a partition that was initially set to the default system value to a user-defined value in response to one or more indications of user input.

Window manager module 6 may maintain information that indications the respective positions of partitions within graphical user interface 12 and/or user interface 4. In some examples, the respective positions of the partitions may be based on one or more reference points defined in a coordinate system superimposed on user interface device 4 and/or graphical user interface 12. Window manager module 6 may change the position of a partition based on user input. In some examples, window manager module 6 may maintain information about the changed position of the partition. Window manager module 6 may also manager the creation and deletion of partitions in response to indications of user inputs and/or machine generated events.

In some examples, window manager module 6 maintains information that indicates one or more alignments of partitions. For instance, window manager module 6 may maintain information that indicates a first partition is horizontally aligned to the left of and adjacent to a second partition. In another example, window manager module 6 may maintain information that indicates a first partition is vertically aligned above and adjacent to a second partition. Although the previous two examples are provided for example purposes, any suitable alignments may be indicated by information maintained by window manager module 6.

Window manager module 6 may maintain information about each window that is output for display in graphical user interface 12 by user interface device 4. Each window may have a corresponding window identifier that window manager module 6 may use to uniquely identify the respective window. Window manager module 6 may maintain mappings between partition identifiers and window identifiers to manager and determine which windows are included in which respective partitions. In some examples, window manager module 6 may store such mappings between window identifiers and partition identifiers in an associative array such as a map or dictionary, or window manager module 6 may use any other suitable data structure. Window manager module 6 may maintain information about the respective positions of each window within with a partition and/or within graphical user interface 12.

In some examples, window manager module 6 maintains information that indicates a number of and/or identity of display devices. For instance, computing device 2 may be operatively coupled to multiple display devices. Window manager module 6 may cause user interface device 4 to output for display, different partitions of a multiple partition graphical user interface to different display devices. Window manager 6 may maintain information that indicates which partition is displayed on which display device. In some examples, window manager module 6 may maintain information that indicates which windows are included on which display devices.

Computing device 2, in some examples, includes I/O (Input/Output) module 8. I/O module 8 may receive information from window manager module 6 and output such information to devices with output functionality (e.g., user interface device 4, a communications unit, etc.). I/O module 8 may receive information from devices with input functionality (e.g., user interface device 4, a communications unit, etc.). For example, I/O module 8 may receive information that defines graphical user interface 12 from window manager module 6 and one or more of application modules 10A-10N. I/O module 8, based on the received information, may cause user interface device 4 to output graphical user interface 12 for display. In some examples, I/O module 8 may determine an indication of user input performed at user interface device 4, and send such information to one or more of window manager module 6 and/or application modules 10A-10N.

As shown in FIG. 1, mobile computing device 2, in some examples, includes one or more application modules 10A-10N. Application modules 8 may include functionality to perform any variety of operations on computing device 2. For instance, application modules 10A-10N may include an email application, text messing application, instant messaging application, weather application, video conferencing application, social networking application, weather application, stock market application, emergency alert application, sports application, office productivity application, multimedia player, etc. As further described herein, in some examples, an application module of application modules 10A-10N may indicate content for display within graphical user interface 12 and further define intent information that indicates which partition to include the content within graphical user interface 12. Although shown as operable by computing device 2, one or more of application modules 10A-10N may be operable by a remote computing device that is communicatively coupled to computing device 2. In such examples, an application module executing at a remote computing device may cause the remote computing device to send the content and intent information using any suitable form of data communication (e.g., wired or wireless network, short-range wireless communication such as Near Field Communication or Bluetooth, etc.). In some examples, a remote computing device, may be a computing device that is separate from computing device 2. For instance, the remote computing device may be operatively coupled to computing device 2 by a network. Examples of a remote computing device may include, but is not limited to a server, smartphone, tablet computing device, smart watch, and desktop computer. In some examples, a remote computing device may not be an integrated component of computing device 2.

Window manager module 6 may send information to I/O module 8, which causes user interface device 4 to output for display, graphical user interface 12. In some examples, graphical user interface 12 may be a multiple-partition graphical user interface. A multiple-partition graphical user interface may define multiple different partitions 14A-14B within a graphical user interface. Partitions 14A-14B may each be non-overlapping regions of graphical user interface 12, as shown in FIG. 1. In some examples, partitions 14A-14B may by visually indicated by border lines within graphical user interface 12 that are output for display by user interface device 4. In other examples, partitions 14A-14B may not be visually indicated by border lines within graphical user interface 12. In some examples, window manager module 6 may cause user interface device 4 to output a divider line 13 between partitions. For instance, divider line 13 may displayed by user interface device 4. In some examples, window manager module 6 may change the size of partitions 14A-14B in response to an indication of user input that drags or otherwise moves divider line 13 in a horizontal direction. By moving divider line in a horizontal direction, one of partitions 14A-14B may become larger while the other partition becomes smaller.

Each of partitions 14A-14B may be separately referenced by window manager module 6. That is each of partitions 14A-14B is uniquely addressable by window manager module 6. For instance, manager module 6 may assign and maintain a different partition identifier to each of partitions 14A and 14B. In some examples, the partition identifier may uniquely identify the corresponding partition. In some examples, window manager module 6 may assign windows to different partitions using the partition identifier.

In some examples, window manager module 6 may display one or more windows 16A-16B in partitions 14A-14B. A window may be a graphical user interface element that includes content. Content may include, but is not limited to, text, images, moving images, or any other visually perceptible construct. In some examples, a window may be generated, modified, maintained, and/or deleted by computing device 2 based one or more processes or threads that correspond to one or more of application modules 10A-10N. Window manager module 6 may change or move the window from one partition to another in response to one or more indications of user input. For instance, window manager module 6 may receive an indication of user input (e.g., a drag gesture, double-tap, etc.) performed at user interface device 4, which causes window manager module 6 to move a window from one partition to another. In some examples, a multi-touch or single-touch gesture may cause window manager module 6 to move the window to a different partition. In some examples, input from a keyboard or other input device may cause window manager module 6 to move the window to a different partition. Window manager module 6 may move windows between different partitions in response to indications of user input and/or machine-generated events. For instance, an application module executing at computing device 2 or executing at a remote computing device may generate an event, Window manager module 6 may move one or more windows in response to the event. In some examples, the event may be based on or include intent information.

As shown in FIG. 1, partition 14A includes window 16A and partition 16B includes window 16B. Window 16A may correspond to a video application module included within application modules 10A-10N. Window 16A includes content such as video 18B and images 18A, 18C, and 18D that represent selectable videos. Window 16B may correspond to a calendar application module included within application modules 10A-10N. Window 16B includes calendar 20A and agenda items 20B and 20C, which may represent calendar events occurring during one or more days of the month view illustrated in calendar 20A. In the example of FIG. 1, window manager module 6 may maintain a data structure with associations between window identifiers and partition identifiers. The data structure may include data that indicates an association between a window identifier of window 16A and a partition identifier of partition 14A. Similarly, the data structure may include data that indicates an association between a window identifier of window 16B and a partition identifier of partition 16B.

Window manager module 6 may determine and/or provide for one or more display modes. A display mode may define an arrangement of one or more partitions within graphical user interface 12. Window manager module 6 may change display modes in response to indications of user input and/or machine-generated events. For instance, an application module executing at computing device 2 or executing at a remote computing device may generate an event. Window manager module 6 may change display modes in response to the event. In some examples, the event may be based on or include intent information. In other examples, window manager module 6 may change display modes in response to one or more indications of user input. The indications of user input may include, but are not limited to, single- and/or multi-touch gestures, voice commands, input performed using a keyboard and/or mouse.

As shown in FIG. 1, window manager module 6 may provide a display mode referred to as “two-up” mode in which the two partitions are displayed side-by-side and adjacent to one another. In other example of “two-up mode,” window manager module 6 may display the two partitions, wherein partition 14A, for example, is vertically adjacent to partition 14B, and wherein the top border partition 14B is adjacent to the bottom border of partition 14A. In some examples, each of windows 16A and 16B are displayed to substantially fill the respective partitions. That is, in some examples substantially filling a partition may include filling more than 80% of the partition area with a window. In another example, substantially filling a partition may include filling more than 95% of the partition area with a window. In some examples, substantially filling a partition may include filling a range of 70%-100% of the area of the partition with a window.

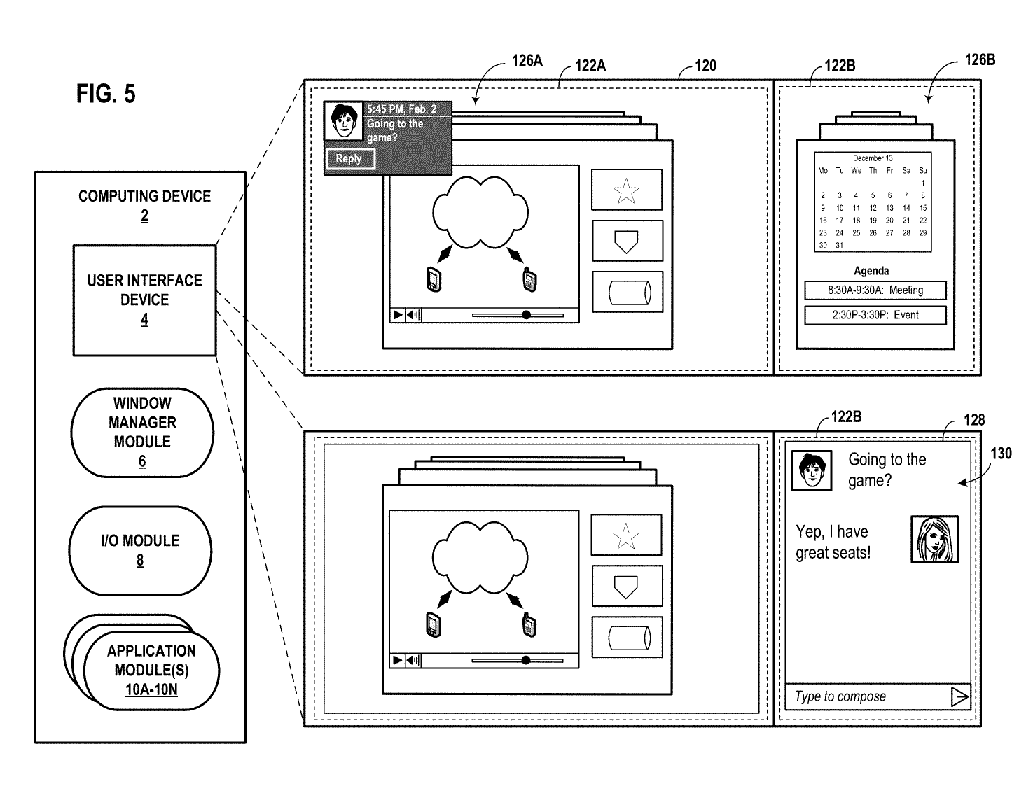

In a “one-up mode” of display, graphical user interface 12 may include a single partition. In “one-up mode” a window within the single partition may substantially fill the partition. In a “stack mode” of display, one or more partitions may include a stack of windows, such as illustrated in FIG. 5. As further described in FIG. 5, in “stack mode” a user may navigate through different windows in the stack by providing indications of user input at user interface device 4. For instance, the user may provide an indication of a user input (e.g., a swipe or multi-touch input) at user interface device 4, which causes different windows in a stack to be visually scrolled or iterated in the graphical user interface. Window manager module 6 may also provide one or more “hybrid modes” in which a window of first partition may substantially fill the first partition, while a second partition may display a stack of windows.

In some examples, window manager module 6 may change the display mode in response to one or more indications of user input. For instance, window manager module 6 may receive an indication of user input performed at user interface device 4, which causes window manager module 6 to change display modes. In some examples, a multi-touch or single-touch gesture may cause window manager module 6 to change display modes. In some examples, input from a keyboard or other input device may cause window manager module 6 to move the window to a different partition. Window manager module 6 may change modes in response to a machine-generated event. For instance, an application module executing at computing device 2 or executing at a remote computing device may generate an event. Window manager module 6 may change the display mode in response to the event. In some examples, the event may be based on or include intent information.

In some examples, each respective partition of partitions 14A-15B may include a respective set of windows, such as window 16A-16) that are arranged in a respective predefined alignment that is imposed by the window manager module. That is, window manager module 6, upon assigning a window to a particular partition may impose the position of the window within the partition. In other words, rather than allowing a window to be placed at any location within the partition, window manager module 6 imposes a position within the partition to include the window. In some examples, window manager module 6 may not allow a window to be placed at any location within the partition. Instead, in some examples, window manager module 6 may only allow the window to be positioned at a single location within the partition. In some examples, window manager module 6 may position a respective set of windows within a partition based on a location of the respective partition within the graphical user interface. That is, window manager module 6 may define a partition as corresponding to a particular region of a graphical user interface, and may position the set of windows within the partition based on a location of the partition within the graphical user interface.

In some examples, window manager module 6 may arrange a set of windows in a predefined alignment. A predefined alignment may be an arrangement of windows within a partition that is defined by a default setting in window manager module 6. That is, in some examples, the predefined alignment may be an arrangement of windows within a partition that is not determined in response to an indication of user input. As shown in FIG. 5, a predefined alignment may include an arrangement of a set of windows as a stack of windows along a y-axis in an (x,y,z) coordinate space. In the example of FIG. 5, predefined alignment may include arranging the set of windows as stacked, wherein the windows are not completely overlapping one another. In some examples, the area each window, except the window with its area visible, may be more than 50% overlapped by one or more windows.

In accordance with techniques of the disclosure, a window manager module may determine, based on intent information specified in a message that is generated by an application module, a partition of a multiple-partition graphical user interface in which to display content indicated by a message. In other words, rather than the window manager module (or operating system) specifying which partition to display content indicated by a message, techniques of the disclosure allow the application module itself that generated and/or sent the message to indicate which partition to display content indicated by the message. Thus, techniques of the disclosure may allow the application module to specify which partition to display such content by including intent information within the message. The techniques are now further described in detail with reference to FIG. 1.

In some examples, window manager module 6 that is operable by a computing device 2, may output for display, graphical user interface 12 comprising a plurality of partitions 14A-14B, wherein each respective partition of the plurality of partitions 14A-14B is a non-overlapping region of graphical user interface 12 and each respective partition of the plurality of partitions is individually addressable by the window manager module 6. Window manager module 6 may receive from an application module (such as application module 10A or an application module executing at a remote computing device), a request to output for display, information indicated by the application module. The request may address a particular partition of the plurality of partitions 14A-14B in which to display the information.

In some examples, a request comprises data that indicates information for a computing device to display. In some examples, a request may include but is not limited to an instant message, video conference message, emergency alert message, a multimedia message, email message, and a Short Message Service (SMS) message. In some examples, a request may be a message generated by an application module. In some examples, a request may include an application module generated event received by an operating system that causes the operating system to display a content (such as in a window). In some examples, a request may be defined in a message. The message may include structured data in binary or textual form. In some examples, the message may be generated by an application module executing at computing device 2 (e.g., application modules 10A-10N) or an application module executing at a remote computing device. In some examples, information included in the request may be content or data that references content, wherein the content is displayable at a user-interface device. For instance, information included in the request may be, but is not limited to, text, one or more images, and/or one or more moving images. In some examples, information included in the request may be data that references content such as a Uniform Resource Identifier, Uniform Resource Locator, pointer, or any other suitable data that points to, addresses, or references content.

In some examples, information included in the request may also include intent information. That is, information included in a request may include: intent information, content, and/or data that references content. Intent information may provide for late run-time binding between components executable at computing device 2. Components may include, but are not limited to: processes, threads, application modules, and windows. In some examples, intent information may specify one or more operations to be performed. In some examples, intent information may include data, such as static and/or dynamic data. For instance, intent information may include data that indicates which partition to include content that is specified in a request. In some examples, window manager module 6 may include one or more handling functions that process the intent information. That is, window manager module 6 may determine the appropriate handling function based on data included in the intent information. In some examples, intent information may include data specific to one or more components and/or specific to window manager module 6 (or an operating system).

In accordance with techniques of the disclosure, intent information included in a request may indicate a partition in which to display content that is indicated by the request. In some examples, the intent information may indicate a unique identifier of the partition in which to display the content. In some examples, intent information may specify data usable by window manager module 6 to select the partition in which to display the content of the request. For instance, data usable by window manager module 6 and included in the intent information may indicate a “primary” or “non-primary” partition. In some examples, “primary” and “non-primary” may represent partition types. Based on whether the intent information indicates a “primary” or “non-primary” partition, window manager module 6 may determine the corresponding partition and include the content in the determined partition. In some examples, window manager module 6 may determine primary and non-primary partitions based on the relative size of the primary partition to the non-primary partition.

In some examples, the size of one or more of the partitions is under the control of the user. For instance, responsive to receiving an indication of user input, window manager module 6 may change the size of one or more of the primary and non-primary partition(s). For instance, the indication of user input may cause window manager module 6 to redefine the previously primary partition as a non-primary partition, if the size of the previously primary partition is reduced to a smaller size than the previously non-primary partition (the inverse may also occur if the previously non-primary partition is increased to a larger size than the previously primary partition). In such examples, if intent information specifies for content to be displayed in a primary partition, window manager module 6 will cause the content to be included in the previously non-primary partition (and now primary partition based on the change in size responsive to the user input).

Window manager module 6 may maintain information that identifies at least one of the partitions as a “primary” partition. In some examples, the “primary” partition may be the largest partition by size of area in the plurality of partitions included in graphical user interface 12. In some examples, the “primary partition” may be the partition that window manager module 6 has determined is most actively interacted with by the user (e.g. editing, navigating, scrolling windows or content within windows) and/or other machine-driven events. In some examples, window manager module 6 may set a partition as the “primary partition” based on an indication of user input received at user interface device 4.

Window manager module 6 may maintain information that identifies at least one of the partitions as a “non-primary” partition. In some examples, the “non-primary” partition may be a partition that is smaller in area than the largest partition in the plurality of partitions included in graphical user interface 12. In some examples, a “non-primary” may be the partition that window manager module 6 has determined is less actively interacted with by the user (e.g. editing, navigating, scrolling windows or content within windows) and/or other machine-driven events, than the primary partition. In some examples, window manager module 6 may set a partition as the “non-primary partition” based on an indication of user input received at user interface device 4.

In some examples, data usable by window manager module 6 and included in the intent information may indicate a relative position of a partition within a multiple-partition graphical user interface. For instance, data included in the intent information may indicate “left-most,” “right-most,” “top-most,” “bottom-most”, partition. As an example where partitions are positioned side-by-side horizontally, the “left-most” partition may be the partition that shares its left border with the left border of graphical user interface 12. As another example where partitions are positioned side-by-side vertically, the “top-most” partition may be the partition that shares its top border with the top border of graphical user interface 12. Based on whether the intent information indicates a “left-most,” “right-most,” “top-most,” “bottom-most” partition, window manager module 6 may determine the corresponding partition and include the content in the determined partition.

In some examples, data usable by window manager module 6 and included in the intent information may indicate a relative size of a partition within a multiple-partition graphical user interface. For instance, data included in the intent information may indicate “largest,” “smallest,” “nth-largest,” “nth-smallest,” partition (where n is defined in the intent information). As an example, the “largest” partition may be the partition that has the largest area relative to other partitions. As another example, the “smallest” partition may be the partition that has the smallest area relative to other partitions. Based on whether the intent information indicates a “largest,” “smallest,” “nth-largest,” “nth-smallest,” partition, window manager module 6 may determine the corresponding partition and include the content in the determined partition.

In some examples, data usable by window manager module 6 and included in the intent information may indicate one or more operations for window manager module 6 to perform in order to display content in a specific partition of graphical user interface 12. The intent information may specify other operations in addition to the operations for window manager module 6 to perform in order to display content in a specific partition of graphical user interface 12. In some examples, the one or more operations indicated in the intent information may be user-defined, machine-defined, and/or a combination of user- and machine-defined operations.

In the example of FIG. 1, computing device 2 may receive a request to display a content of an instant message that was generated by an application module executing at a remote computing device. The content may include text composed by a user of a remote computing device. In some examples, the request may not be directly received from the remote computing device, but may instead by received after the request has taken an indirect route through one or more servers, network devices, etc. I/O manager module 8 may initially receive the request from the remote computing device. One of application modules 10, which may be an instant messaging application, may receive the request from I/O manager module 8. In some examples, window manager module 6 may receive the request from I/O manager module 8. In some examples, window manager module 6 and the instant message application may receive all or a portion of the information included in the request.

In the example of FIG. 1, the instant messaging application may send the content and the intent information to window manager module 6. Window manager module 6 may determine the content indicated by the request and output for display notification 22. Notification 22 may be a graphical element that includes the content of the request. In some examples, notification 22 may be a notification window. Notification 22 may also include one or more graphical elements, such as button 24. A user may provide an indication of user input to select button 24 in order to reply using the instant messaging application executing at computing device 2. For instance, window manager module 6 may receive an indication of user input that is responsive to notification 22. In some examples, if the user does not provide an indication of user input in response to notification 22, notification 22 may disappear after a timeout. In some examples, if the user does not provide an indication of user input in response to notification 22, window manager module 6 may determine intent information associated with the request. In some examples, if a user provides an indication of user input to select button 24, window manager module 6 may determine intent information associated with the request. As further described herein, window manager module 6 may output for display, a window within a particular partition responsive to the indication of user input.

As previously described above, window manager module 6 may determine intent information of the request. For instance, window manager module 6 may select the intent information indicated by the request by parsing information included in the request. In the example of FIG. 1, the intent information may indicate “non-primary” partition. Window manager module 6 may determine that partition 14B is a “non-primary” partition and display a window 16C that corresponds to the instant messaging application in partition 14B. in some examples, window 16C may replace window 16B in partition 14B. Based on the intent information generated by the remote computing device, window manager module 6 may determine the intent information to display window 16C in the “non-primary” partition (e.g., partition 14B) rather than the “primary” partition (e.g., partition 14A). Techniques of the disclosure may therefore allow the sending application module (e.g., an instant messaging application executing at the remote computing device) to specify the “non-primary” partition as the partition to display the content of the received request. In this way, the sending application module may send the instant message content, such that it is visible to the user within graphical user interface 12, but does not interrupt the user's workflow or otherwise interfere with content displayed at the “primary” partition.

As shown in FIG. 1, window manager module 6 may cause user interface device 4 to output for display, and based at least in part on the request that addresses partition 14B of the plurality of partitions, a particular window 16C that includes the information (e.g., instant message text) indicated by the application module (e.g., instant messaging application executing at the remote computing device). For instance, window 16C may include content text and image 22A and text and image 22B. Window 16C may also include a text input field 23 and a send button 24. Text input field 23 may display characters that correspond to key indicated by user inputs. Send button 24 may cause the instant messaging application at computing device 2 to send text inputted by the user to the remote computing device. Additional techniques of the disclosure are further described herein.

FIG. 2 is a block diagram illustrating an example computing device, in accordance with one or more aspects of the present disclosure. FIG. 2 illustrates only one particular example of computing device 2 (as also illustrated in FIG. 1), and many other examples of computing device 2 may be used in other instances and may include a subset of the components included in example computing device 2 or may include additional components not shown in FIG. 2.

As shown in the example of FIG. 2, computing device 2 includes one or more processors 40, one or more input devices 42, one or more communication units 44, one or more output devices 46, one or more storage devices 48, and user interface device 4. Storage devices 48 of computing device 2 also include operating system 54, window manager module 6, I/O module 8, and applications 10A-10N. Communication channels 50 may interconnect each of the components 40, 42, 44, 46, 48, 6, 8, 10A-10N, 12, and 54, for inter-component communications (physically, communicatively, and/or operatively). In some examples, communication channels 50 may include a system bus, a network connection, one or more inter-process communication data structures, or any other method for communicating data between hardware and/or software.

One or more input devices 42 of computing device 2 may receive input. Examples of input are tactile, audio, and video input. Input devices 42 of computing device 2, in one example, includes a mouse, keyboard, voice responsive system, video camera, microphone or any other type of device for detecting input from a human or machine. In some examples, input device 42 may be a presence-sensitive input device, which may include a presence-sensitive screen, touch-sensitive screen, etc.

One or more output devices 46 of computing device 2 may generate output. Examples of output are tactile, audio, and video output. Output devices 46 of computing device 2, in one example, include a presence-sensitive screen, sound card, video graphics adapter card, speaker, cathode ray tube (CRT) monitor, liquid crystal display (LCD), or any other type of device for generating output to a human or machine. Output devices 46 may include display devices such as cathode ray tube (CRT) monitor, liquid crystal display (LCD), or any other type of device for generating visual output.

One or more communication units 44 of computing device 2 may communicate with external devices via one or more networks by transmitting and/or receiving network signals on the one or more networks. For example, computing device 2 may use communication unit 44 to transmit and/or receive radio signals on a radio network such as a cellular radio network. Likewise, communication units 44 may transmit and/or receive satellite signals on a satellite network such as a GPS network. Examples of communication unit 44 include a network interface card (e.g. such as an Ethernet card), an optical transceiver, a radio frequency transceiver, a GPS receiver, or any other type of device that can send and/or receive information. Other examples of communication units 44 may include Bluetooth®, GPS, 3G, 4G, and Wi-Fi® radios found in mobile devices as well as Universal Serial Bus (USB) controllers.

In some examples, user interface device 4 of computing device 2 may include functionality of input devices 42 and/or output devices 46. In some examples, user interface 12 may refer to a presence-sensitive display. In the example of FIG. 2, user interface device 4 may include a presence-sensitive input device, such as a presence-sensitive screen, touch-sensitive screen, etc. In some examples, a presence sensitive input device may detect an object at and/or near the presence-sensitive input device. As one example range, a presence-sensitive input device may detect an object, such as a finger or stylus that is within 2 inches or less of the presence-sensitive screen. The presence-sensitive input device may determine a location (e.g., an (x,y) coordinate) of the presence-sensitive input device at which the object was detected. In another example range, a presence-sensitive input device may detect an object 6 inches or less from the presence-sensitive input device and other ranges are also possible. The presence-sensitive input device may determine the location of the screen selected by a user's finger using capacitive, inductive, and/or optical recognition techniques. In some examples, user interface device 4 provides output to a user using tactile, audio, or video stimuli as described with respect to output device 46. For instance, user interface device 4 may include a display device that presents a user interface, such as user interface 12 of FIG. 1.

While illustrated as an integrated component of computing device 2, user-interface device 12 may, in some examples, be an external component that shares a data path with other components of computing device 2 for transmitting and/or receiving input and output. For instance user-interface device 12 may be a built-in component of computing device 2 located within and physically connected to the external packaging of computing device 2 (e.g., a screen on a mobile phone). In another example, user-interface device 12 may be an external component of computing device 2 located outside and physically separated from the packaging of computing device 2 (e.g., a monitor, a projector, etc. that shares a wired and/or wireless data path with a tablet computer). In some examples, user interface device 4, when located outside of and physically separated from the packaging of computing device 2, may collectively refer two components: a presence-sensitive input device for receiving input and a display device for providing output.

One or more storage devices 48 within computing device 2 may store information for processing during operation of computing device 2. In some examples, storage device 48 is a temporary memory, meaning that a primary purpose of storage device 48 is not long-term storage. Storage devices 48 on computing device 2 may configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 48, in some examples, also include one or more computer-readable storage media. Storage devices 48 may be configured to store larger amounts of information than volatile memory. Storage devices 48 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 48 may store program instructions and/or data associated with operating system 54, window manager module 6, I/O manager module 8, and application modules 10A-10N.

One or more processors 40 may implement functionality and/or execute instructions within computing device 2. For example, processors 40 on computing device 2 may receive and execute instructions stored by storage devices 48 that provide the functionality of operating system 54, window manager module 6, I/O manager module 8, and application modules 10A-10N. These instructions executed by processors 40 may cause computing device 2 to store and/or modify information, within storage devices 48 during program execution. Processors 40 may execute instructions of operating system 54, window manager module 6, I/O manager module 8, and application modules 10A-10N to cause user interface device 4 to display user interface 12. That is, operating system 54, window manager module 6, I/O manager module 8, and application modules 10A-10N may be operable by processors 40 to perform various functions described herein, including receiving indications of a gesture at locations of user interface device 4 and causing user interface device 4 to present user interface 12 at user interface device 4.

In accordance with aspects of this disclosure, user interface device 4 may output, by a window manager module 6 that is operable by processors 40, and for display, a graphical user interface comprising a plurality of partitions. For instance, window manager module 6 may cause user interface device 4 to output the graphical user interface comprising the plurality of partitions. Each respective partition of the plurality of partitions may be a non-overlapping region of the graphical user interface and each respective partition of the plurality of partitions may be individually addressable by the window manager module 6. In some examples, each respective partition of the plurality of partitions includes a respective set of windows that are arranged in a respective predefined alignment that is imposed by the window manager module, located within the respective partition, and shared by each window within the respective set of windows. In some examples, the respective set of windows is positioned within the respective partition of the plurality of positions based on a location of the respective partition within the graphical user interface. In some examples, a set of windows may include zero or more windows. In some examples, a set of windows may include one or more windows.

Window manager module 6 may receive from an application module (e.g., application module 10A or an application module executing at a remote computing device), a request to output, for display, information indicated by the application module. The request may address a particular partition of the plurality of partitions in which to display the information. Window manager module 6 may output for display, and based at least in part on the request that addresses the particular partition of the plurality of partitions, a particular window in the respective, predefined alignment within the particular partition, the particular window including the information indicated by the application module. For instance, window manager module 6 may send data to user interface device 4 via one or more of communication channels 50 that causes user interface device 4 to output the graphical user interface for display.

In some examples, techniques of the disclosure may be initiated by application modules (e.g., “developer-driven”). In some examples, an application module may generate intent information in a request that triggers a window of the application module to be displayed in a particular partition. For instance, the application module may cause the window to open in a “non-primary” partition, which may be a smaller partition than the largest partition of the graphical user interface. In some examples, a notification may cause a window to be displayed in a particular partition. For instance, an application module may specify that notifications generated by the application module include intent information that causes windows generated in response to the notification to launch in a particular partition. For instance, a video conferencing application may specify that notifications generated by the video conferencing application always include intent information that causes windows generated in response to the notification to launch in a “non-primary” partition. Window manager module 6, upon receiving the notification from the video conferencing application may output the window for display in a “non-primary” partition. Although “primary” and “non-primary” partitions are have been used for example purposes, any suitable partition types may be used.

In some examples, techniques of the disclosure may be initiated by window manager module 6 (e.g., “system-driven”). For instance, window manager module 6 may determine that a window generated by an application module is better suited for display in a “non-primary” partition than a “primary partition.” In some examples, window manager module 6 may store data that indicates a previous user action. The data may indicate the action taken by a user for a window of an application module. Window manager module 6 may, based on the data that indicates the previous user action, automatically cause user interface device 4 to output a window from the application module indicated by the data to the same partition that was indicated in the previous user action. That is, if the user previously caused the window of a particular application module (e.g., using one or more user inputs) to be displayed in a particular partition, window manager module 6 may automatically cause a later-generated window of the particular application to be displayed in the same, particular position. In this way, window manager module 6 may store data that indicates an action historically taken by a user that resulted in a window being displayed in a particular partition. Window manager module 6 may later use this information to automatically display windows generated by the same application module in the same, particular partition.

In some examples, window manager module 6 may determine, based on a request, data that indicates a previous action of a user that was responsive to a previous request. The previous action may be based on a previous indication of user input in response to the previous request, wherein the request corresponds to the previous request based at least in part on at least one of an application module that generated the request, a window that corresponds to the application, and a sender of the request. For instance, the data may indicate that a user previously moved a window generated by a particular application module to a “non-primary” partition although the window was initially displayed in a “primary” partition, Window manager module 6 may determine, based on the data, that the request is generated by the same application as the previous request and automatically output a window with content indicated by the request for display in the “non-primary” partition. That is, window manager module 6 may determine, based on the data that indicates the previous action of the user that was responsive to the previous request, the particular partition of the plurality of partitions into which to include the window that includes content indicated by the request.

In some examples, window manager module 6 may determine an action that has content that points to a transient or ongoing interaction. For example, window manager module 6 may determine that tapping a notification for a media rich email would launch the email window in the “primary” partition, whereas tapping a notification for an email containing only a written question would launch into the “non-primary” partition. That is, window manager module 6 may determine, based on the content selected in response to an indication of user input, which partition to output the content for display. For instance, window manager module 6 may determine that more dynamic content may be output for display in the “primary” partition, while less dynamic information may be output for display in the “non-primary” partition. That is, window manager module 6 may determine at least one property of the content, such as whether it is dynamic information or non-dynamic information. In some examples, a property of the content may indicate the degree of dynamism of information. In some examples, a property of the content may indicate privacy or security that corresponds to the content. In some examples, a property of the content may include any data that characterizes and/or describes the content.

In some examples, window manager module 6 may output for display, at least a portion of content indicated by the request. For instance, the window manager module 6 may output a subset of the content indicated by the request. As an example, an instant message may include a set of text. The computing device may output a subset of the text in a notification window that includes a button selectable by the user to reply. Responsive to receiving an indication of user input that is in response to the portion of content, window manager module 6 may determine at least one property of the content. Window manager module 6 may determine, based the at least one property of the content, the particular partition of the plurality of partitions.

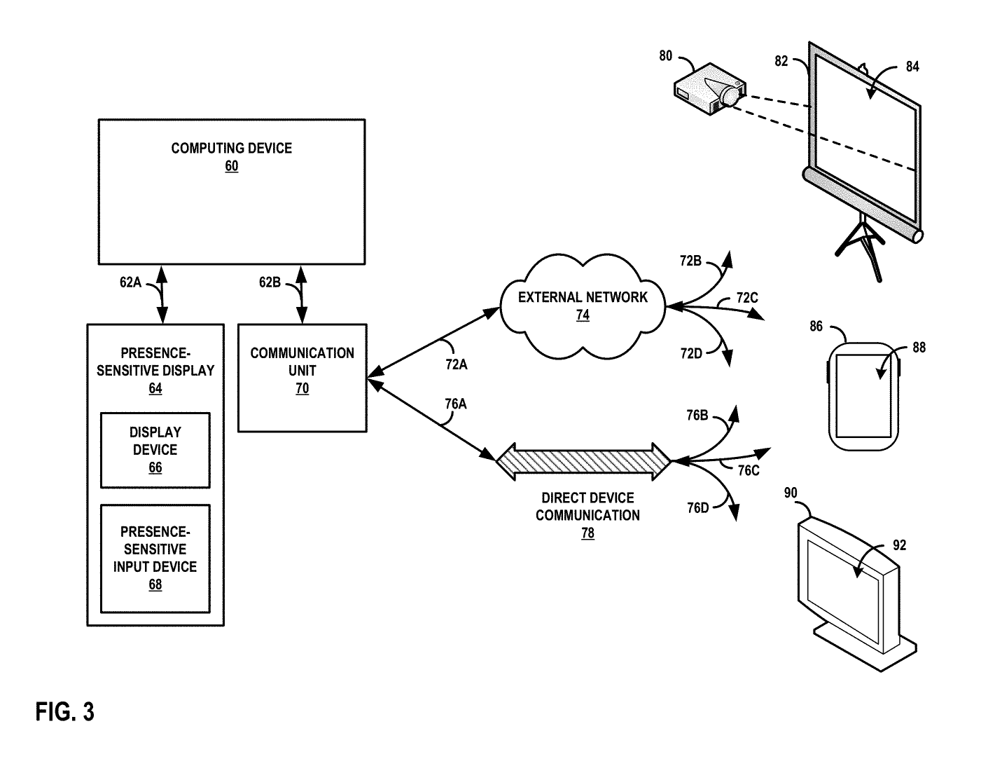

FIG. 3 is a block diagram illustrating an example computing device that outputs graphical content for display at a remote device, in accordance with one or more techniques of the present disclosure. Graphical content, generally, may include any visual information that may be output for display, such as text, images, a group of moving images, etc. The example shown in FIG. 3 includes a computing device 60, presence-sensitive display 64, communication unit 70, projector 80, projector screen 82, mobile device 86, and visual display device 90. Although shown for purposes of example in FIGS. 1 and 2 as a stand-alone computing device 10, a computing device such as computing device 60 may, generally, be any component or system that includes a processor or other suitable computing environment for executing software instructions and, for example, need not include a presence-sensitive display.

As shown in the example of FIG. 3, computing device 60 may be a processor that includes functionality as described with respect to processor 40 in FIG. 2. In such examples, computing device 60 may be operatively coupled to presence-sensitive display 64 by a communication channel 62A, which may be a system bus or other suitable connection. Computing device 60 may also be operatively coupled to communication unit 70, further described below, by a communication channel 62B, which may also be a system bus or other suitable connection. Although shown separately as an example in FIG. 3, computing device 60 may be operatively coupled to presence-sensitive display 64 and communication unit 70 by any number of one or more communication channels.

In other examples, such as illustrated previously by computing device 10 in FIGS. 1-2, a computing device may refer to a portable or mobile device such as mobile phones (including smart phones), laptop computers, etc. In some examples, a computing device may be a desktop computers, tablet computers, smart television platforms, cameras, personal digital assistants (PDAs), servers, mainframes, etc.

Presence-sensitive display 64, like user interface device 4 as shown in FIG. 1, may include display device 66 and presence-sensitive input device 68. Display device 66 may, for example, receive data from computing device 60 and display the graphical content. In some examples, presence-sensitive input device 68 may determine one or more user inputs (e.g., continuous gestures, multi-touch gestures, single-touch gestures, etc.) at presence-sensitive display 64 using capacitive, inductive, and/or optical recognition techniques and send indications of such user input to computing device 60 using communication channel 62A. In some examples, presence-sensitive input device 68 may be physically positioned on top of display device 66 such that, when a user positions an input unit over a graphical element displayed by display device 66, the location at which presence-sensitive input device 68 corresponds to the location of display device 66 at which the graphical element is displayed.

As shown in FIG. 3, computing device 60 may also include and/or be operatively coupled with communication unit 70. Communication unit 70 may include functionality of communication unit 44 as described in FIG. 2. Examples of communication unit 70 may include a network interface card, an Ethernet card, an optical transceiver, a radio frequency transceiver, or any other type of device that can send and receive information. Other examples of such communication units may include Bluetooth, 3G, and WiFi radios, Universal Serial Bus (USB) interfaces, etc. Computing device 60 may also include and/or be operatively coupled with one or more other devices, e.g., input devices, output devices, memory, storage devices, etc. that are not shown in FIG. 3 for purposes of brevity and illustration.

FIG. 3 also illustrates a projector 80 and projector screen 82. Other such examples of projection devices may include electronic whiteboards, holographic display devices, and any other suitable devices for displaying graphical content. Projector 80 and projector screen 82 may include one or more communication units that enable the respective devices to communicate with computing device 60. In some examples, the one or more communication units may enable communication between projector 80 and projector screen 82. Projector 80 may receive data from computing device 60 that includes graphical content. Projector 80, in response to receiving the data, may project the graphical content onto projector screen 82. In some examples, projector 80 may determine one or more user inputs (e.g., continuous gestures, multi-touch gestures, single-touch gestures, etc.) at projector screen using optical recognition or other suitable techniques and send indications of such user input using one or more communication units to computing device 60. In such examples, projector screen 82 may be unnecessary, and projector 80 may project graphical content on any suitable medium and detect one or more user inputs using optical recognition or other such suitable techniques.

Projector screen 82, in some examples, may include a presence-sensitive display 84. Presence-sensitive display 84 may include a subset of functionality or all of the functionality of user interface device 4 as described in this disclosure. In some examples, presence-sensitive display 84 may include additional functionality. Projector screen 82 (e.g., an electronic whiteboard), may receive data from computing device 60 and display the graphical content. In some examples, presence-sensitive display 84 may determine one or more user inputs (e.g., continuous gestures, multi-touch gestures, single-touch gestures, etc.) at projector screen 82 using capacitive, inductive, and/or optical recognition techniques and send indications of such user input using one or more communication units to computing device 60.

FIG. 3 also illustrates mobile device 86 and visual display device 90. Mobile device 86 and visual display device 90 may each include computing and connectivity capabilities. Examples of mobile device 86 may include e-reader devices, convertible notebook devices, hybrid slate devices, etc. Examples of visual display device 90 may include other semi-stationary devices such as televisions, computer monitors, etc. As shown in FIG. 3, mobile device 86 may include a presence-sensitive display 88. Visual display device 90 may include a presence-sensitive display 92. Presence-sensitive displays 88, 92 may include a subset of functionality or all of the functionality of presence-sensitive display 4 as described in this disclosure. In some examples, presence-sensitive displays 88, 92 may include additional functionality. In any case, presence-sensitive display 92, for example, may receive data from computing device 60 and display the graphical content. In some examples, presence-sensitive display 92 may determine one or more user inputs (e.g., continuous gestures, multi-touch gestures, single-touch gestures, etc.) at projector screen using capacitive, inductive, and/or optical recognition techniques and send indications of such user input using one or more communication units to computing device 60.

As described above, in some examples, computing device 60 may output graphical content for display at presence-sensitive display 64 that is coupled to computing device 60 by a system bus or other suitable communication channel. Computing device 60 may also output graphical content for display at one or more remote devices, such as projector 80, projector screen 82, mobile device 86, and visual display device 90. For instance, computing device 60 may execute one or more instructions to generate and/or modify graphical content in accordance with techniques of the present disclosure. Computing device 60 may output the data that includes the graphical content to a communication unit of computing device 60, such as communication unit 70. Communication unit 70 may send the data to one or more of the remote devices, such as projector 80, projector screen 82, mobile device 86, and/or visual display device 90. In this way, computing device 60 may output the graphical content for display at one or more of the remote devices. In some examples, one or more of the remote devices may output the graphical content at a presence-sensitive display that is included in and/or operatively coupled to the respective remote devices.

In some examples, computing device 60 may not output graphical content at presence-sensitive display 64 that is operatively coupled to computing device 60. In other examples, computing device 60 may output graphical content for display at both a presence-sensitive display 64 that is coupled to computing device 60 by communication channel 62A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 60 and output for display at presence-sensitive display 64 may be different than graphical content display output for display at one or more remote devices.

Computing device 60 may send and receive data using any suitable communication techniques. For example, computing device 60 may be operatively coupled to external network 74 using network link 72A. Each of the remote devices illustrated in FIG. 3 may be operatively coupled to network external network 74 by one of respective network links 72B, 72C, and 72D. External network 74 may include network hubs, network switches, network routers, etc., that are operatively inter-coupled thereby providing for the exchange of information between computing device 60 and the remote devices illustrated in FIG. 3. In some examples, network links 72A-72D may be Ethernet, ATM or other network connections. Such connections may be wireless and/or wired connections.

In some examples, computing device 60 may be operatively coupled to one or more of the remote devices included in FIG. 3 using direct device communication 78. Direct device communication 78 may include communications through which computing device 60 sends and receives data directly with a remote device, using wired or wireless communication. That is, in some examples of direct device communication 78, data sent by computing device 60 may not be forwarded by one or more additional devices before being received at the remote device, and vice-versa. Examples of direct device communication 78 may include Bluetooth, Near-Field Communication, Universal Serial Bus, WiFi, infrared, etc. One or more of the remote devices illustrated in FIG. 3 may be operatively coupled with computing device 60 by communication links 76A-76D. In some examples, communication links 76A-76D may be connections using Bluetooth, Near-Field Communication, Universal Serial Bus, infrared, etc. Such connections may be wireless and/or wired connections.

In accordance with techniques of the disclosure, computing device 60 may be operatively coupled to visual display device 90 using external network 74. Computing device 60 may output for display at presence-sensitive display 92 a graphical user interface comprising a plurality of partitions, wherein each respective partition of the plurality of partitions is a non-overlapping region of the graphical user interface and each respective partition of the plurality of partitions is individually addressable by the window manager module. For instance, computing device 60 may send data that includes a representation of the graphical user interface to communication unit 70. Communication unit 70 may send the data that includes the representation of the graphical user interface to visual display device 90 using external network 74. Visual display device 90, in response to receiving the data using external network 74, may cause presence-sensitive display 92 to output the graphical user interface. In some examples, each respective partition of the plurality of partitions in the graphical user interface includes a respective set of windows that are arranged in a respective predefined alignment that is imposed by the window manager module. A set of windows may be located within the respective partition, and the predefined alignment may be shared by each window within the respective set of windows. The respective set of windows may be positioned within the respective partition of the plurality of positions based on a location of the respective partition within the graphical user interface.

In some examples, computing device 60 may receive, from an application module, a request to output, for display, information indicated by the application module, wherein the request addresses a particular partition of the plurality of partitions in which to display the information. In some examples, computing device 60 may receive the request via communication unit 70 from a remote computing device that is executing the application module. In some examples, computing device 60 may receive the request from an application module executing at computing device 60.

In some examples, computing device 60 may output for display, via communication unit 70 and based at least in part on the request that addresses the particular partition of the plurality of partitions, a particular window in the respective common, predefined alignment within the particular partition, the particular window including the information indicated by the application module. Communication unit 70 may send information via external network 74 to visual display device 90 that causes visual display device 90 to display the particular window in the respective, predefined alignment within the particular partition.

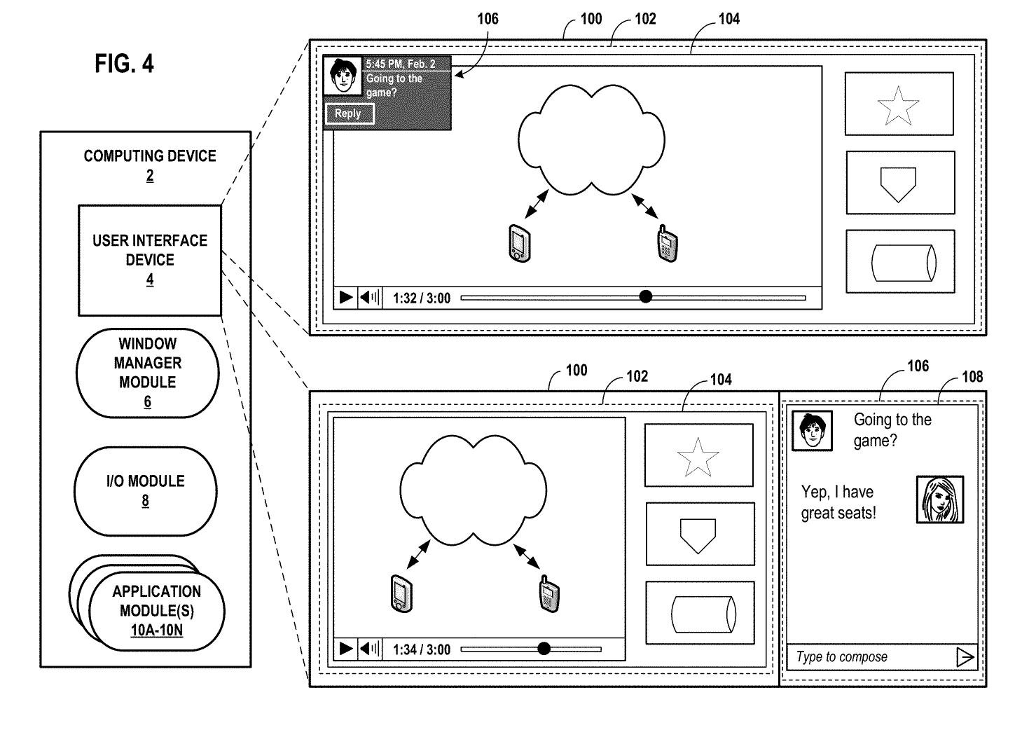

FIG. 4 is a conceptual diagram illustrating an example computing device that is configured to generate an additional partition in response to request and display content in the additional partition, in accordance with one or more aspects of the present disclosure. As shown in the example of FIG. 4, window manager module 6 may initially cause user interface device 4 to display graphical user interface 100. Graphical user interface 100 may include a single partition 102 in “one-up” display mode. In other examples, graphical user interface 100 may include multiple partitions, such as “two-up” display mode. In any case, window manager module 6 may include window 104, which includes various content.

In the example of FIG. 4, window manager module 6 may receive a request to output for display, an instant message indicated by an application module executing on a remote computing device, The request may specify a “non-primary” partition as the partition in which to display the content indicated by the request. In FIG. 4, window manager module 6 may initially only display a single partition 102 in “one-up” display mode. Responsive to determining that the request specifies a “non-primary” partition, window manager module 6 may define, based on the request, a new partition 106 in graphical user interface 104. That is, window manager module 6 may generate a new “non-primary” partition 106 in the multiple partition graphical user interface 100. Window manager module 6, may generate window 108 within new partition 106. Window 108 may include content that was indicated in the request sent by the remote computing device. In this way, window manager module 6 may define a new partition in response to a request, based on information included in the request, and display content indicated by the request in the new partition (e.g., in a window that is included within the new partition).

FIG. 5 is a conceptual diagram illustrating an example computing device that is configured to transition between display modes in response to a request, in accordance with one or more aspects of the present disclosure. As shown in the example of FIG. 5, window manager module 6 may initially cause user interface device 4 to display graphical user interface 120. Graphical user interface 120 may include two partitions 122A and 122B in “two-up stack” display mode. In “two-up stack” display mode, window manager module 6 may cause graphical user interface 120 to include two partitions 122A and 122B. Within each of partitions 122A and 122B, window manager module 6 may include window stacks 126A and 126B. Window stack 126A may be a visual representation of a set of windows in a stacked arrangement. In some examples, the set of windows in the stacked arrangement may appear visually recessed within graphical user interface 120. For instance, a window at the forefront of the stack may not substantially fill the entire partition 122A. As shown in FIG. 5, window stack 126A and window stack 126B may appear visually recessed within graphical user interface 120.

In the example of FIG. 5, window manager module 6 may receive a request to output for display, an instant message indicated by an application module executing on a remote computing device. The request may specify a “non-primary” partition as the partition in which to display the content indicated by the request. Responsive to determining that the request specifies a “non-primary” partition, window manager module 6 may determine that graphical user interface 120 is currently in “two-up stack” display mode. That is, window manager module 6 may determine, based on the request, a second display mode, wherein the second display mode arranges at least one set of windows of the respective set of windows differently than first display mode within a partition that includes the at least one set of windows. In some examples, window manager module 6, responsive to determining that the partition indicated by the request is currently displaying windows in a stack mode, may transition to a mode in which the partition indicated by the request includes a window that substantially fills the partition, wherein the window includes information indicated by the request. That is, rather than displaying the window that includes the information indicated by the request in stack mode, window manager module 6 may display the window in the indicated partition to substantially fill the partition.

In the example of FIG. 5, window manager module 6 may determine a second display mode, for example, a “hybrid display” mode in which partition 122A includes window stack 126A in partition 122A and further includes window 128 that substantially fills partition 122B. The second display mode, e.g., “hybrid mode,” may arrange at least one set of windows of the respective set of windows differently than first “two-up stack” display mode. As shown in FIG. 5, window 128 includes information indicated by the request, which may have been indicated by an application module that generated the request. For instance, the information may include all or a portion of content 130, such as text “Going to the game?”. In this way, window manager module 6 may, based on the partition indicated by the request, change a first display mode to a second display mode.

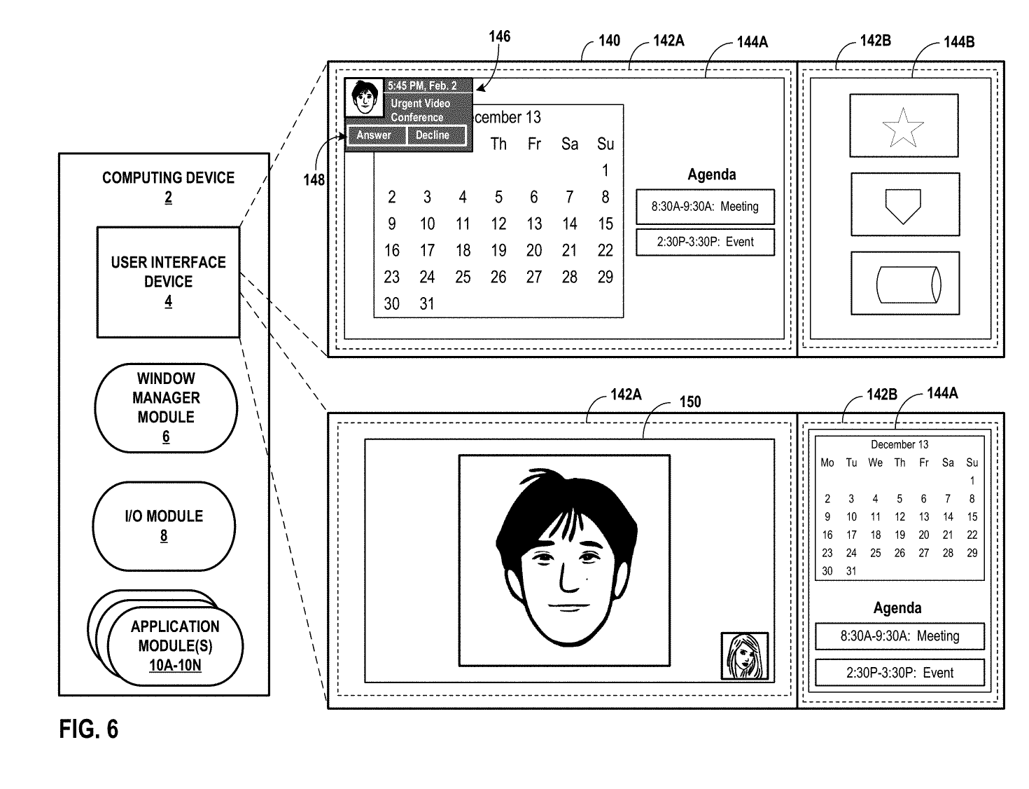

FIG. 6 is a conceptual diagram illustrating an example computing device that is configured to move a window from one partition to another in response to a request, in accordance with one or more aspects of the present disclosure. As shown in the example of FIG. 6, window manager module 6 may initially cause user interface device 4 to display graphical user interface 140. Graphical user interface 140 may include two partitions 122A and 122B in “two-up stack” display mode. In “two-up stack” display mode, window manager module 6 may cause graphical user interface 120 to include two partitions 142A and 142B. Within each of partitions 142A and 142B, window manager module 6 may include windows 144A and 144B. Windows 144A and 144B include content as illustrated in FIG. 6.

In the example of FIG. 6, window manager module 6 may receive a request to output for display, a video conference session indicated by an application module executing on a remote computing device. Window manager module 6 may determine a type of information indicated by the request that is generated by the application module. Examples of a type of information may include, but are not limited to, a priority of the information, a content type of the information, and a sender of the information. Examples of priority (in decreasing order of urgency) may include “urgent,” “normal,” and “low.” In some examples, an application module may specify in the request that the priority of the information indicated by the request is “urgent,” “normal,” or “low.” Examples of a content type may include, but are not limited to, a video conference, picture, movie, instant message, audio, web page, user and/or device proximity notification. Examples of a sender may include identifying information of a user and/or computing device that initiated and/or sent the request.

Window manager module 6 may determine a priority of information indicated by a request. Window manager module 6 may determine that the priority of the incoming request is “urgent.” Based on a determination of the type of information, for example, that the priority of the incoming request is greater than a “normal” priority, window manager module 6 may move window 144A in partition 142A to partition 142B. That is, window manager module 6 may determine that the priority of the incoming request satisfies a threshold (e.g., is greater than a threshold), and responsive to determining that the priority satisfies the threshold, window manager module 6 may move one or more windows. If the priority of the incoming request does not satisfy the threshold, window manager module 6 may output the information indicated by the request without moving any of the windows in graphical user interface 140. As shown in FIG. 6, window manager module 6 may display the information indicated by the request in partition 142A. That is, based on determining the type of information indicated by the request, window manager module 6 may move a window from a first partition to a second partition and may display a new window in the first partition, wherein the new window includes information indicated by the request.

In some example, window manager module 6, may determine a content type of information indicated in the request as the type of information and move one or more windows. Window manager module 6 may determine, based on the content type, the particular partition of the plurality of partitions in which to display a window that includes content indicated by the request. For instance, window manager module 6 may determine one or more user preferences or system default preferences that indicate whether to move a window responsive to receiving an incoming request based on a particular content type. A user and/or system default preference may indicate that for a particular content type, window manager module 6 may move one or more windows to one or more different partitions. In some examples, window manager module 6 may move one or more windows to one or more different partitions based on data indicating past user interactions to move one or more windows between partitions when a request of a particular content type was received.

In some example, window manager module 6, may determine identifying information of a user and/or computing device that initiated the request as the type of information and move one or more windows. In some examples, the identifying information of the user and/or computing device may be included in or accompany the request. For instance, window manager module 6 may determine one or more user preferences or system default preferences that indicate whether to move a window responsive to receiving an incoming request based on identifying information of a user and/or computing device. A user and/or system default preference may indicate that for a particular user and/or computing device that initiated the request, window manager module 6 may move one or more windows to one or more different partitions. In some examples, window manager module 6 may move one or more windows to one or more different partitions based on data indicating past user interactions to move one or more windows between partitions when a request was received from a particular user and/or computing device.

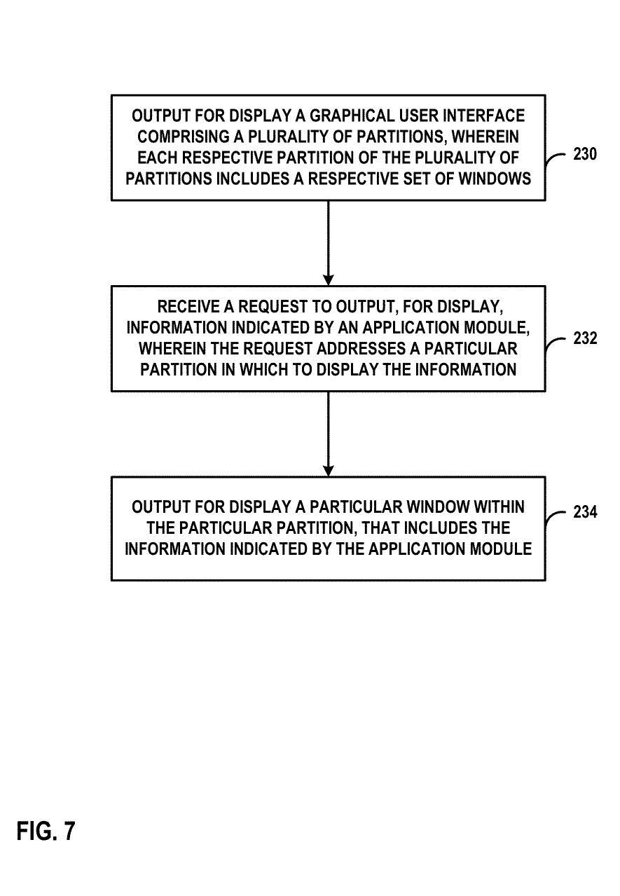

FIG. 7 is a flow diagram illustrating example operations of a computing device to determine, based on intent information specified in a message, a partition of a multiple-partition graphical user interface in which to display content specified by the message, in accordance with one or more aspects of the present disclosure. For purposes of illustration, the example operations are described below within the context of computing device 2, as shown in FIGS. 1 and 2.

Computing device 2 may initially output for display, a graphical user interface comprising a plurality of partitions (230). Each respective partition of the plurality of partitions may be a non-overlapping region of the graphical user interface and each respective partition of the plurality of partitions is individually addressable by computing device 2. Each respective partition of the plurality of partitions may include a respective set of windows that are arranged in a respective predefined alignment that is imposed by computing device 2, located within the respective partition, and shared by each window within the respective set of windows. In some examples, the respective set of windows may be positioned within the respective partition of the plurality of positions based on a location of the respective partition within the graphical user interface.

Computing device 2 may receive from an application module, a request to output, for display, information indicated by an application module (232). The request may address a particular partition of the plurality of partitions in which to display the information. In some examples, the application module may be executing at computing device 2. In other examples, the application module may be executing at a remote computing device.

Computing device 2 may output for display, and based at least in part, on the request that addresses the particular partition of the plurality of partitions, a particular window in the respective, predefined alignment within the particular partition, the particular window including the information indicated by the application module (234).

### EXAMPLE 1

A method comprising: outputting, by a window manager module that is operable by a computing device, for display, a graphical user interface comprising a plurality of partitions, wherein each respective partition of the plurality of partitions is a non-overlapping region of the graphical user interface that is individually addressable by the window manager module and includes a respective set of windows that are arranged in a respective predefined alignment imposed by the window manager module and located within the respective partition, the respective predefined alignment shared by each window within the respective set of windows, and wherein the respective set of windows is positioned within the respective partition of the plurality of positions based on a location of the respective partition within the graphical user interface; receiving, by the window manager module and from an application module, a request to output, for display, information indicated by the application module, wherein the request addresses a particular partition of the plurality of partitions in which to display the information; and outputting, by the window manager module, for display, and based at least in part on the request, a particular window in the respective, predefined alignment within the particular partition, the particular window including the information indicated by the application module.

### EXAMPLE 2

The method of example 1, further comprising: defining, by the computing device and based on the request, a new partition in the graphical user interface, wherein the new partition is the particular partition of the plurality of partitions, wherein the new partition includes the particular window.

### EXAMPLE 3

The method of example 2, wherein the respective set of windows is arranged based at least in part on a first display mode, the further comprising: determining, by the window manager module and based on the request, a second display mode, wherein, in the second display mode at least one set of windows of the respective set of windows is arranged differently within a partition that includes the at least one set of windows than in the first display mode, wherein the particular window including the information indicated by the application module is output for display in the second display mode.

### EXAMPLE 4

The method of any of examples 1-3, wherein the particular window is a first window and wherein the particular partition is a first partition, the method further comprising: determining, by the computing device, a type of the information indicated by the application module; and moving, by the computing device and based on the type of the information, a second window from the first partition to a second partition.

### EXAMPLE 5

The method of any of examples 1-4, wherein the type of information indicated by the application module comprises at least one of a priority of the information, a content type of the information, and a sender of the information.

### EXAMPLE 6

The method of any of examples 1-5, wherein the application module is executing at a remote computing device.

### EXAMPLE 7

The method of any of examples 1-6, wherein the request comprises at least one of an instant message, video conference message, emergency alert message, a multimedia message, email message, and a Short Message Service (SMS) message.

### EXAMPLE 8

The method of any of examples 1-7, further comprising: outputting, by the window manager module and for display, a notification window that includes at least a portion of the information indicated by the application module; receiving, by the window manager module, an indication of user input that is responsive to the notification window; and wherein outputting, by the window manager module, for display, the particular window within the particular partition is responsive to the indication of user input.

### EXAMPLE 9

The method of any of examples 1-8, wherein the request indicates content and intent information, wherein the method of example 1 further comprises: selecting, by the window manager module, the intent information indicated by the request; and determining, by the window manager module and based on the intent information, the particular partition of the plurality of partitions.

### EXAMPLE 10

The method of any of examples 1-9, wherein the request indicates content and intent information, wherein the method of any of examples 1-9 further comprises: determining, by the window manager module and based on the content, a content type of content indicated by request; and determining, by the window manager and based on the content type, the particular partition of the plurality of partitions.

### EXAMPLE 11

The method of any of examples 1-11, further comprising: determining, by the window manager module and based on the request, data that indicates a previous action of a user that was responsive to a previous request, wherein the previous action was based on a previous indication of user input in response to the previous request, wherein the request corresponds to the previous request based at least in part on at least one of the application module that generated the request, a window that corresponds to the application, and a sender of the request; and determining, by the window manager and based on the data that indicates the previous action of the user that was responsive to the previous request, the particular partition of the plurality of partitions.

### EXAMPLE 12

The method of any of examples 1-11, further comprising: outputting, by the window manager module and for display, at least a portion of content indicated by the request; responsive to receiving an indication of user input that is in response to the portion of content, determining, by the window manager module, at least one property of the content; determining, by the window manager module and based the at least one property of the content, the particular partition of the plurality of partitions.

### EXAMPLE 13

The method of any of examples 1-12, wherein the plurality of partitions includes a primary partition and a secondary partition, wherein the primary partition corresponds to a first region of the graphical user interface that is larger than a second region of the graphical user interface, and wherein the first region does not overlap with the second region.

### EXAMPLE 14

A computer-readable storage medium encoded with instructions that, when executed, cause at least one processor to: output, by a window manager module that is operable by the at least one processor, and for display; a graphical user interface comprising a plurality of partitions, wherein each respective partition of the plurality of partitions is a non-overlapping region of the graphical user interface and each respective partition of the plurality of partitions is individually addressable by the window manager module, wherein each respective partition of the plurality of partitions includes a respective set of windows that are arranged in a respective predefined alignment that is imposed by the window manager module, located within the respective partition, and shared by each window within the respective set of windows, and wherein the respective set of windows is positioned within the respective partition of the plurality of positions based on a location of the respective partition within the graphical user interface; receive, by the window manager module and from an application module, a request to output, for display, information indicated by the application module, wherein the request addresses a particular partition of the plurality of partitions in which to display the information; and output, by the window manager module, for display, and based at least in part on the request, a particular window in the respective, predefined alignment within the particular partition, the particular window including the information indicated by the application module.

### EXAMPLE 15

The computer-readable storage medium of example 14, encoded with instructions that, when executed, cause at least one processor to: select, from the request indicates content and intent information, the intent information indicated by the request; and determine, based on the intent information, the particular partition of the plurality of partitions.

### EXAMPLE 16

The computer-readable storage medium of example 14, wherein the plurality of partitions includes a. primary partition and a. secondary partition, wherein the primary partition corresponds to a first region of the graphical user interface that is larger than a second region of the graphical user interface, and wherein the first region does not overlap with the second region.

### EXAMPLE 17

A computing device comprising at least one processor, wherein the at least one processor is configured to: output, by a window manager module that is operable by the at least one processor, and for display, a graphical user interface comprising a plurality of partitions, wherein each respective partition of the plurality of partitions is a non-overlapping region of the graphical user interface and each respective partition of the plurality of partitions is individually addressable by the window manager module, wherein each respective partition of the plurality of partitions includes a respective set of windows that are arranged in a respective predefined alignment that is imposed by the window manager module, located within the respective partition, and shared by each window within the respective set of windows, and wherein the respective set of windows is positioned within the respective partition of the plurality of positions based on a location of the respective partition within the graphical user interface; receive, by the window manager module and from an application module, a request to output, for display, information indicated by the application module, wherein the request addresses a particular partition of the plurality of partitions in which to display the information; and output, by the window manager module, for display, and based at least in part on the request, a particular window in the respective, predefined alignment within the particular partition, the particular window including the information indicated by the application module.

### EXAMPLE 18

The computing device of example 17, wherein the at least one processor is configured to: select, from the request indicates content and intent information, the intent information indicated by the request; and determine, based on the intent information, the particular partition of the plurality of partitions.

### EXAMPLE 19

The computing device of example 17, wherein the plurality of partitions includes a primary partition and a secondary partition, wherein the primary partition corresponds to a first region of the graphical user interface that is larger than a second region of the graphical user interface, and wherein the first region does not overlap with the second region.

### EXAMPLE 20

The computing device of example 17, wherein the application module is executing at a remote computing device.

### EXAMPLE 21

A method comprising: outputting, by a computing device, and for display, a graphical user interface comprising a plurality of partitions, wherein each respective partition of the plurality of partitions is a non-overlapping region of the graphical user interface and each respective partition of the plurality of partitions is individually addressable by the computing device, wherein each respective partition of the plurality of partitions includes a respective set of windows that are arranged in a respective predefined alignment that is imposed by the computing device and located within the respective partition, the respective predefined alignment being shared by each window within the respective set of windows, and wherein the respective set of windows is positioned within the respective partition of the plurality of positions based on a location of the respective partition within the graphical user interface; processing, by the computing device, a request from an application module to output, a particular window for displaying information indicated by the application module, wherein the request addresses a particular partition of the plurality of partitions in which to display the information; and outputting, by the computing device, tier display, and based at least in part on the request, the particular window in the respective, predefined alignment within the particular partition, the particular window including the information indicated by the application module.

### EXAMPLE 22

A computer-readable storage medium encoded with instructions that when executed, cause the at least one processor of the computing device to perform any of the methods of Example 21 and Examples 2-13.

### EXAMPLE 23

A device comprising at least one module that is operable by at least one processor to perform any of the methods of Example 21 and Examples 2-13.

### EXAMPLE 24

A method comprising: outputting, by a window manager module that is operable by a computing device, and for display, a graphical user interface comprising a plurality of partitions, wherein each respective partition of the plurality of partitions is a non-overlapping region of the graphical user interface and each respective partition of the plurality of partitions is individually addressable by the window manager module, wherein each respective partition of the plurality of partitions includes a respective set of windows that are arranged in a respective predefined alignment that is imposed by the window manager module, located within the respective partition, and shared by each window within the respective set of windows, and wherein the respective set of windows is positioned within the respective partition of the plurality of positions based on a location of the respective partition within the graphical user interface; receiving, by the window manager module and from an application module, a request to output, a particular window for displaying information indicated by the application module, wherein the request addresses a particular partition of the plurality of partitions in which to display the information; and outputting, by the window manager module, for display, and based at least in part on the request, the particular window in the respective, predefined alignment within the particular partition, the particular window including the information indicated by the application module.

### EXAMPLE 25

A computer-readable storage medium encoded with instructions that when executed, cause the at least one processor of the computing device to perform any of the methods of Example 24 and Examples 2-13.

### EXAMPLE 26

A device comprising at least one module that is operable by at least one processor to perform any of the methods of Example 24 and Examples 2-13.

### EXAMPLE 27

The method of any of Examples 1-13, further comprising: receiving, by the window manager module, an indication of user input that changes a size of the primary partition to be smaller than a size of a non-primary partition that corresponds to the second region; and redefining, by the window manager module, the primary partition to correspond to the second region, and the non-primary partition to correspond to the first region.

In one or more examples, the functions described may be implemented in hardware, software, firmware, or any combination thereof if implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the embodiment, certain acts or events of any of the methods described herein can be performed in a different sequence, may be added, merged, or left out all together (e.g., not all described acts or events are necessary for the practice of the method). Moreover, in certain embodiments, acts or events may be performed concurrently, e.g., through multi-threaded processing, interrupt processing, or multiple processors, rather than sequentially.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
outputting, by a window manager module that is operable by a computing device, for display, a graphical user interface comprising a plurality of partitions, wherein each respective partition of the plurality of partitions is a non-overlapping region of the graphical user interface that is individually addressable by the window manager module and includes a respective set of windows that are arranged in a respective predefined alignment imposed by the window manager module and located within the respective partition, wherein the respective predefined alignment is shared by each window within the respective set of windows, wherein the respective set of windows is positioned within the respective partition of the plurality of partitions based on a location of the respective partition within the graphical user interface, and wherein a particular application from a plurality of applications currently executing at the computing device is configured to provide information for display within any of the plurality of partitions;
receiving, by the window manager module and from the particular application, a request to output, for display, information indicated by the particular application, wherein the request identifies a particular partition from the plurality of partitions in which to display the information, and wherein the particular partition is associated with one of the plurality of applications other than the particular application;
outputting, by the window manager module, for display, a notification window that includes at least a portion of the information indicated by the particular application, wherein the notification window visually overlaps at least a portion of one partition from the plurality of partitions;
receiving, by the window manager module, an indication of user input detected at a location associated with the notification window; and
responsive to receiving the indication of the user input:
determining, by the window manager module, a type of the information indicated by the particular application;
identifying, by the window manager module and based on the type of the information and data indicating a past user interaction to move one or more windows between partitions when a notification including information having a same type as the type of the information was output, an existing window to output the information indicated by the particular application, the existing window having an initial location within the respective, predefined alignment within the particular application;
moving, by the window manager module and based on the type of the information, the existing window from the initial location in the respective, predefined alignment within the particular partition to a new location in a different partition from the plurality of partitions; and
outputting, by the window manager module, for display, and based at least in part on the request, the information indicated by the particular application within a new window at the initial location of the existing window within the respective, predefined alignment within the particular partition.

2. (canceled)

3. The method of claim 1, wherein the respective set of windows is arranged for display based at least in part on a first display mode, the method further comprising:
determining, by the window manager module and based on the request, a second display mode, wherein, in the second display mode at least one set of windows of the respective set of windows is arranged differently within a partition that includes the at least one set of windows than in the first display mode, wherein the particular window including the information indicated by the particular application is output for display in the second display mode.

4. (canceled)

5. The method of claim 1, wherein the type of information indicated by the particular application comprises at least one of a priority of the information, a content type of the information, and a sender of the information.

6. (canceled)

7. The method of claim 1, wherein the request comprises at least one of an instant message, video conference message, emergency alert message, a multimedia message, email message, and a Short Message Service (SMS) message.

8. (canceled)

9. The method of claim 1, wherein the request indicates content and intent information, wherein the method further comprises:
selecting, by the window manager module, the intent information indicated by the request; and
determining, by the window manager module and based on the intent information, the particular partition of the plurality of partitions.

10. The method of claim 1, further comprising:
determining, by the window manager and based on the content type, the particular partition of the plurality of partitions.

11. The method of claim 1, further comprising:
determining, by the window manager module and based on the request, the data that indicates the past user interaction to move the one or more windows that was responsive to a previous request, wherein the request corresponds to the previous request based at least in part on at least one of the particular application that generated the request, a window that corresponds to the application, and a sender of the request; and
determining, by the window manager module and based on the data, the particular partition of the plurality of partitions.

12. The method of claim 1, further comprising:
outputting, by the window manager module and for display, at least a portion of content indicated by the request;
responsive to receiving an indication of user input that is in response to the portion of content, determining, by the window manager module, at least one property of the content;
determining, by the window manager module and based the at least one property of the content, the particular partition of the plurality of partitions.

13. The method of claim 1,
wherein the plurality of partitions includes a primary partition and a secondary partition,
wherein the primary partition corresponds to a first region of the graphical user interface that is larger than a second region of the graphical user interface, and
wherein the first region does not overlap with the second region.

14. The method of claim 13, further comprising:
receiving, by the window manager module, an indication of user input that changes a size of the primary partition to be smaller than a size of a non-primary partition that corresponds to the second region; and
redefining, by the window manager module, the primary partition to correspond to the second region, and the non-primary partition to correspond to the first region.

15. A non-transitory computer-readable storage medium encoded with instructions that, when executed, cause at least one processor to:
output, by a window manager module that is operable by the at least one processor, and for display, a graphical user interface comprising a plurality of partitions, wherein each respective partition of the plurality of partitions is a non-overlapping region of the graphical user interface and each respective partition of the plurality of partitions is individually addressable by the window manager module, wherein each respective partition of the plurality of partitions includes a respective set of windows that are arranged in a respective predefined alignment that is imposed by the window manager module, located within the respective partition, and shared by each window within the respective set of windows, wherein the respective set of windows is positioned within the respective partition of the plurality of partitions based on a location of the respective partition within the graphical user interface, and wherein a particular application from a plurality of applications currently executing at the computing device is configured to provide information for display within any of the plurality of partitions;
receive, by the window manager module and from the particular application, a request to output, for display, information indicated by the particular application, wherein the request identifies a particular partition from the plurality of partitions in which to display the information, and wherein the particular partition is associated with one of the plurality of applications other than the particular application;
output, by the window manager module, for display, a notification window that includes at least a portion of the information indicated by the particular application, wherein the notification window visually overlaps at least a portion of one partition from the plurality of partitions;
receive, by the window manager module, an indication of user input detected at a location associated with the notification window; and
responsive to receiving the indication of the user input:
determine a type of the information indicated by the particular application;
identify, based on the type of the information and data indicating a past user interaction to move one or more windows between partitions when a notification including information having a same type as the type of the information was output, an existing window to output the information indicated by the particular application, the existing window having an initial location within the respective, predefined alignment within the particular application;
move, based on the type of the information, the existing window from the initial location in the respective, predefined alignment within the particular partition to a new location in a different partition from the plurality of partitions; and
output, by the window manager module, for display, and based at least in part on the request, the information indicated by the particular application within a new window at the initial location of the existing window within the respective, predefined alignment within the particular partition.

16. The non-transitory computer-readable storage medium of claim 15, encoded with instructions that, when executed, cause at least one processor to:
select, from the request indicates content and intent information, the intent information indicated by the request; and
determine, based on the intent information, the particular partition of the plurality of partitions.

17. The non-transitory computer-readable storage medium of claim 15,
wherein the plurality of partitions includes a primary partition and a secondary partition,
wherein the primary partition corresponds to a first region of the graphical user interface that is larger than a second region of the graphical user interface, and
wherein the first region does not overlap with the second region.

18. A computing device comprising at least one processor, wherein the at least one processor is configured to:
output, by a window manager module that is operable by the at least one processor, and for display, a graphical user interface comprising a plurality of partitions, wherein each respective partition of the plurality of partitions is a non-overlapping region of the graphical user interface and each respective partition of the plurality of partitions is individually addressable by the window manager module, wherein each respective partition of the plurality of partitions includes a respective set of windows that are arranged in a respective predefined alignment that is imposed by the window manager module, located within the respective partition, and shared by each window within the respective set of windows, wherein the respective set of windows is positioned within the respective partition of the plurality of partitions based on a location of the respective partition within the graphical user interface, and wherein a particular application from a plurality of applications currently executing at the computing device is configured to provide information for display within any of the plurality of partitions;
receive, by the window manager module and from the particular application, a request to output, for display, information indicated by the particular application, wherein the request identifies a particular partition from the plurality of partitions in which to display the information, and wherein the particular partition is associated with one of the plurality of applications other than the particular application;
output, by the window manager module, for display, a notification window that includes at least a portion of the information indicated by the particular application, wherein the notification window visually overlaps at least a portion of one partition from the plurality of partitions;
receive, by the window manager module, an indication of user input detected at a location associated with the notification window; and
responsive to receiving the indication of the user input:
determine a type of the information indicated by the particular application;
identify, based on the type of the information and data indicating a past user interaction to move one or more windows between partitions when a notification including information having a same type as the type of the information was output, an existing window to output the information indicated by the particular application, the existing window having an initial location within the respective, predefined alignment within the particular application;
move, based on the type of the information, the existing window from the initial location in the respective, predefined alignment within the particular partition to a new location in a different partition from the plurality of partitions; and
output, by the window manager module, for display, and based at least in part on the request, the information indicated by the particular application within a new window at the initial location of the existing window within the respective, predefined alignment within the particular partition.

19. The computing device of claim 18, wherein the at least one processor is configured to:
select, from the request indicates content and intent information, the intent information indicated by the request; and
determine, based on the intent information, the particular partition of the plurality of partitions.

20. The computing device of claim 18,
wherein the plurality of partitions includes a primary partition and a secondary partition,
wherein the primary partition corresponds to a first region of the graphical user interface that is larger than a second region of the graphical user interface, and
wherein the first region does not overlap with the second region.

21. (canceled)
